(19) United States
(12) Patent Application Publication
(10) Pub. No.: US 2016/0379017 A1
(43) Pub. Date: Dec. 29, 2016

(54) APPARATUS, SYSTEM AND TECHNIQUES FOR A SMART CARD COMPUTING DEVICE AND ASSOCIATED HOST DEVICES

(71) Applicant: INTEL CORPORATION, Santa Clara, CA (US)

(72) Inventors: Randolph Y. Wang, Santa Clara, CA (US); Eugene Y. Tang, Beijing (CN); Zeyi Liu, Beijing (CN); Jiqiang Song, Beijing (CN); Paul J. Peng, Beijing (CN); Haiyang Zhu, Beijing (CN); Yunzhen Wang, San Jose, CA (US); Chengwei Bi, Beijing (CN); Fang Wang, Beijing (CN); Sun C. Chan, Fremont, CA (US); Yuanjian Chen, Beijing (CN); Dawei Wang, Beijing (CN); Bing Han, Beijing (CN)

(21) Appl. No.: 15/039,689

(22) PCT Filed: Dec. 27, 2013
(86) PCT No.: PCT/CN2013/090692

§ 371 Date: May 26, 2016

(51) Int. Cl. G06K 7/00; G06K 19/07

(52) U.S. Cl. CPC G06K 7/0056; G06K 19/0723

(57) ABSTRACT

An apparatus, system and other techniques for a smart card device, one or more host devices and a modular computing system comprising a smart card device and one or more host devices are described. For example, an apparatus or example smart card device may comprise one or more processor circuits, an interface coupled to the one or more processor circuits, the smart card device sized to be removably inserted into a host device and the interface configured to removably couple the smart card device to the host device, and logic, at least a portion of which is in hardware, the logic to configure the smart card device based on one or more characteristics of the host device. Other embodiments are described and claimed.

### TECHNICAL FIELD

Examples described herein are generally related to techniques for a smart card device, one or more host devices and a modular computing system comprising a smart card device and one or more host devices.

### BACKGROUND

Modern computing devices continue to evolve in variety of ways. One particular area in which computing devices have evolved is the number and type of devices that users rely on every day. Some devices are carried by users at all times, while other are stationary and/or are only used in specific locations or specific circumstances. These different devices also include a variety of form factors, functionality and computing capabilities. Some efforts have been made to allow for an ad hoc or other combination of devices to perform different functionality and for different uses, where multiple complete devices are utilized. These efforts, however, continue to rely on form factors that may not be desirable for some implementations, require a difficult set up process and often utilize devices that are not appropriate for an intended use. Additionally, the life cycle of modern computing devices continues to decrease as new technology and device features continue to evolve. Current devices require a complete upgrade of all device components to realize these improvements. Therefore, in some embodiments it may be desirable to have a smart card computing device that is arranged with a small and portable form factor, a variety of computing capabilities, that is capable of removably coupling with any number, type and arrangement of different host devices and is easily upgradable without necessitating the upgrade of the host device components. It is with respect to these and other considerations that the embodiments described herein are needed.

### BRIEF DESCRIPTION OF THE DRAWINGS

FIG. 1 illustrates an embodiment of a first apparatus, a second apparatus and/or a first system.

FIG. 2 illustrates an embodiment of a second system

FIG. 3 illustrates an embodiment of a third system.

FIG. 4 illustrates an embodiment of a fourth system.

FIG. 5 illustrates an embodiment of a logic flow.

FIG. 6 illustrates an embodiment of a storage medium.

FIG. 7 illustrates an embodiment of a computing architecture.

### DETAILED DESCRIPTION

Various embodiments are generally directed to techniques for a smart card device, one or more host devices and a modular computing system comprising a smart card device and one or more host devices. Some embodiments are particularly directed to an apparatus comprising a smart card device, the smart card device comprising one or more processor circuits, an interface coupled to the one or more processor circuits, the smart card device sized to be removably inserted into a host device and the interface configured to removably couple the smart card device to the host device, and logic, at least a portion of which is in hardware, the logic to configure the smart card device based on one or more characteristics of the host device. Other embodiments are directed to an apparatus comprising a host device, the host device comprising an enclosure to support one or more input/output (I/O) devices, and an interface to removably couple the host device to a smart card device sized to be removably inserted into an opening of the enclosure, the smart card device comprising one or more processor circuits, an interface to removably couple with the interface of the host device, and logic at least a portion of which is in hardware, the logic to configure the smart card device based on one or more characteristics of the host device. Various embodiments are directed to a system comprising a smart card device and a host device. Other embodiments are described and claimed.

Users of modern computing devices typically own a variety of different devices that they use for different purposes, at different times, in different locations, etc. For example, a typical user may utilize a smartphone, a tablet computer, a laptop computer, a smartwatch or other wearable computing device, a smart speaker or audio/video (A/V) system, a smart remote control and the like. The embodiments are not limited to the number or type of devices described herein. In some embodiments, each of these devices may comprise a completely separate and independent device. For example, each device may include its own processor, memory, power supply/source and the like. In these embodiments, it may be cumbersome for a user to remember and/or carry all of the devices that they need. Additionally, as upgrades become available for any particular component or particular device, it is currently not possible to upgrade only portions of each device. Rather, a user is forced to completely replace any given device to realize the advantages of any available upgrades.

The plurality of devices described above may also present users with the additional problem of synchronizing all of their data across the different devices. Cloud-based services have attempted to solve these and other problems, but these services can be slow and, sometimes, less than trustworthy. Dock-based local synchronization solutions have also been attempted but these solutions can be too ad hoc and thus inconvenient, difficult to use, etc. The amount of data that is synchronized by these conventional approaches tends to be very limited.

Some current solutions attempt to combine a plurality of complete and separate devices in different ways to realize the benefits of certain devices and to attempt to overcome the shortcomings of other devices. For example, a user may attempt to use a smart phone to replace a smart remote control device. While this solution may enable remote control functionality on a smartphone, this solution may be overkill as a typical smartphone may be much more powerful and may use much more power than is needed to operate a satisfactory remote control device. Additionally, the interface may not be suitable for use as a remote control device because the smartphone was not designed with that use in mind.

In other embodiments it may be desirable to combine devices to take advantage of the capabilities of one device that may be lacking or non-existent on another device. For example, it may be desirable to combine a smartphone with a display device and/or a keyboard due to the size limitations of the display and input limitations of a typical smartphone, or to combine a smartphone with a smart speaker due to the audio limitations associated with a smartphone form factor. Current solutions to forming these combinations may include docking (wired and/or wireless), Bluetooth connections, etc. for example. In these embodiments, a first device may be associated with a second device via a wireless pairing procedure or via a physical coupling (e.g. via a cable or a physical dock) of the devices. These combinations may be cumbersome, difficult to establish and may introduce even more devices (e.g. a dock or cable) into the list of already excessive devices that a user may need to own/have available.

In still other embodiments some current devices may be designed to be operative in a number of different configurations and/or form factors. For example, a laptop computer may be designed such that the display is removable for operation as a tablet computing device. These embodiments, while a potential improvement over previous designs, still include many of the shortcomings described above. Additionally, none of the above-described current combination of devices solves the upgrade problem described above. For example, because the pace of today's technology advancement is rapid and new generations of hardware devices rapidly appear, one may be forced into upgrading devices wholesale, throwing away perfectly good components such as touch displays in these existing solutions.

It is with respect to these and other considerations that the embodiments described herein are needed. In some embodiments, a computing device may be decomposed into two main components: a compact “skin core” or smart card device and a “skin” or host device. In various embodiments, while not limited in this respect, the smart card device may be arranged to have a size similar to that of an SD card or a credit card. The smart card device may comprise, among other components, one or more processor circuits, memory, stable storage, one or more communication modules, a power source/supply and components capable of driving one or more input/output (I/O) peripherals (e.g. USB ports, a module that drives a touch display, modules for audio input and output, etc.). In some embodiments, a host device may comprise a number of I/O mechanisms that interact with a human user directly, such as a touch display and a speaker. As described herein, the smart card device may be arranged to be easily and removably detached (or unplugged) from one host device and re-inserted into a different host device.

In some examples, a user may choose to carry a compact smart card device with her, which can be a “naked” smart card device carried in a wallet or inserted into a portable host device such as a wearable device. At a later time or at a different location, the user may take out the smart card device from its current resting place and plug it into a different host device. The number, type and arrangement of host devices may be limitless as a plurality of host devices may be available for different occasions, environments, and special purposes. Some example host devices include but are not limited to a universal television (TV) touch display remote (which, in addition to simulating buttons on a traditional remote, may have sophisticated functionalities such as video thumbnails for a smart TV's channels), a wearable computing device such as a smartwatch (which, while displaying current time most of the time, could also run apps made for the smartwatch), a projector (such as a pico-projector), a flexible (rollable) display, a smart speaker, etc.

In various embodiments, decomposing a system into these discrete components may allow a user to upgrade the smart card device and the host device separately. Additionally, a compact smart card device may allow a user to carry her data, her programs, and her settings with her at all times and the user may choose the most appropriate host device to couple with her smart card device at different places and different times. In various embodiments, in addition to the advantage of separately upgrading the smart card device and the host device, other advantages may additionally be realized by separating the components of the smart card device and the host device. For example, the lack peripherals associated with a smart card device may be a blessing in that it may help to keep the smart card device small, cheap, extremely portable, versatile, and flexible as it is not permanently tied to interface peripherals that are of fixed sizes or fixed functionalities and can be too limiting for particular occasions and uses. Other embodiments are described and claimed.

With general reference to notations and nomenclature used herein, the detailed description that follows may be presented in terms of program procedures executed on a computer or network of computers. These procedural descriptions and representations are used by those skilled in the art to most effectively convey the substance of their work to others skilled in the art.

A procedure is here and is generally conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein that form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

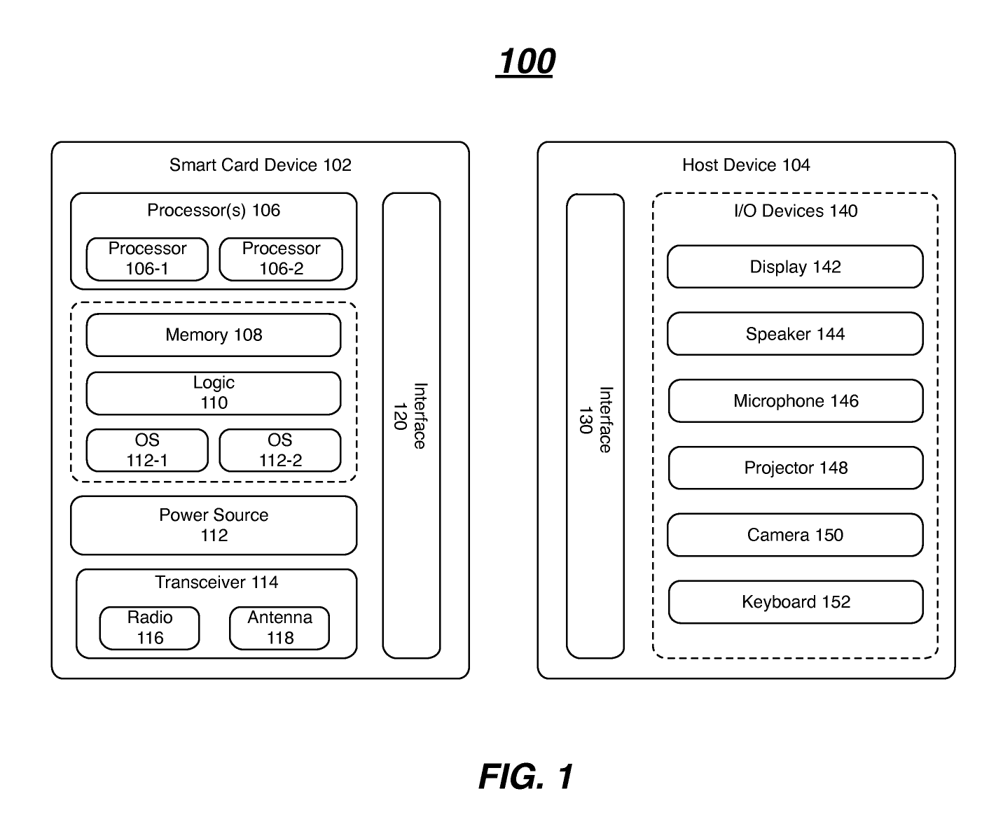

FIG. 1 illustrates a block diagram for a system 100 or an apparatus 100. In one embodiment, the system or apparatus 100 (referred to hereinafter as system 100) may comprise a computer-based system comprising an apparatus 102 and an apparatus 104. In some embodiments, apparatus 102 may comprise a smart card device 102 and apparatus 104 may comprise a host device 104. While referred to hereinafter as a smart card device 102 and a host device 104 for purposes of simplicity and illustration, it should be understood that the devices 102, 104 may comprise any suitable name, label, configuration and/or form factor and still fall within the described embodiments.

The smart card device 102 may comprise a device having a compact form factor arranged to support a number of computing components. As described herein, a smart card, chip card, or integrated circuit card (ICC) device may comprise any pocket-sized or portable card with embedded integrated circuits or other computing components. In some embodiments, the smart card device 102 may be sized and shaped similar to a Secure Digital (SD) card, a mini SD card, a micro SD card, a credit card or other suitable portable and compact form factor. While described herein as having a particular shape or size, one skilled in the art will understand that the embodiments are not limited in this respect.

The smart card device 102 may comprise, for example, one or more processor circuits 106 (e.g. processor 106-1 and processor 106-2), memory 108, logic 110, OS(s) 112 (e.g. OS 112-1 and OS 112-2), power source 112, transceiver 114, radio 116, antenna 118 and interface 120. Although the smart card device 102 shown in FIG. 1 has a limited number of elements in a certain topology, it may be appreciated that the smart card device 102 may include more or less elements in alternate topologies as desired for a given implementation.

In various embodiments, smart card device may comprise a processor circuit 106. The processor circuit 106 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony®Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 106.

As shown in FIG. 1, in some embodiments smart card device 102 may comprise two processor circuits 106-1 and 106-2. While shown as two processor circuits 106-1 and 106-2, in FIG. 1, it should be understood that any number of processor circuits could be used and still fall within the described embodiments. In other embodiments, the processor circuits 106-1 and 106-2 may comprise separate cores of a multi-core processor 106. The embodiments are not limited in this respect.

In some embodiments, the one or more processor circuits 106-1, 106-2 may comprise a first processor circuit 106-1 arranged to execute a first operating system 112-1 and a second processor circuit 106-2 arranged to execute a second operating system 112-2. In various embodiments, the logic 110 may be operative to automatically select one of the first processor circuit 106-1 and first operating system 112-1 or second processor circuit 106-2 and second operating system 112-2 based on the one or more characteristics of the host device 104 as described in more detail below.

The first processor circuit 106-1 may operate at a first frequency and the second processor circuit 106-2 may operate at a second frequency less than the first frequency in some embodiments. For example, the first processor circuit 106-1 may comprise a central processing unit (CPU) capable of executing a full featured operating system 112-1, such as an Android operating system, iOS operating system, OS X operating system, Linux operating system, Windows operating system or any other suitable operating system. Processor circuit 106-2, on the other hand, may comprise a low power, low frequency processor circuit such a microcontroller (MCU) or the like. Processor circuit 106-2 may be operative to execute a boot OS, real-time OS (RTOS), run-time OS or limited functionality OS 112-2 that is designed for a specific purpose, application or device. The embodiments are not limited in this respect.

In various embodiments, smart card device 102 may comprise or include a memory unit 108. The memory unit 108 may store, among other types of information, logic 110 and OS 112-1 and OS 112-2. The memory unit 108 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. While shown as being included with memory 108 in FIG. 1, it should be understood that logic 110 and/or OS 112-1, 112-2 may be located elsewhere within smart card device 102 and still fall within the described embodiments.

In some embodiments, smart card device 102 may comprise logic 110. Examples of logic 110 may include but are not limited to executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein. In some embodiments, at least a portion of logic 110 is implement in hardware. Other embodiments are described and claimed.

Smart card device 102 may comprise a power source 112 in various embodiments. In some embodiments, power source 112 may comprise a battery such as a lithium ion battery or the like. Power source 112 may be operative to provide power to one or more of the components of smart card device 102 and may additionally be operative to provide power to one or more of I/O devices 140 of host device 104 when the smart card device 102 and host device 104 are coupled together as described in more detail below. The embodiments are not limited in this respect.

In various embodiments, smart card device 102 may include an interface 120. Interface 120 may comprise a plurality of input/output (I/O) pins or ports in some embodiments. For example, the interface 120 may be operative to removably and communicatively couple smart card device 102 with host device 104 via corresponding interface 130. In various embodiments, the interface 120 and interface 130 may be operative to enable or arranged to support plug and play operation between the smart card device 102 and a plurality of host devices. In other embodiments, the interface 120 may enable or support hot swapping or hot plugging of the smart card device 102 with a plurality of host devices. Other embodiments are described and claimed.

Smart card device 102 may comprise one or more wireless transceivers 114 in some embodiments. Each of the wireless transceivers 114 may be implemented as physical wireless adapters or virtual wireless adapters sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 114 may comprise or implement various communication techniques to allow the smart card device 102 to communicate with other electronic devices. For instance, the wireless transceivers 114 may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the smart card device 102 may implement different types of wireless transceivers 114. Each of the wireless transceivers 114 may implement or utilize a same or different set of communication parameters to communicate information between various electronic devices. In one embodiment, for example, each of the wireless transceivers 114 may implement or utilize a different set of communication parameters to communicate information between smart card device 102 and any number of other devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the wireless transceivers 114. The embodiments are not limited in this context.

In various embodiments, the wireless transceivers 114 may implement different communication parameters offering varying bandwidths, communications speeds, or transmission range. For instance, a first wireless transceiver may comprise a short-range interface implementing suitable communication parameters for shorter range communications of information, while a second wireless transceiver may comprise a long-range interface implementing suitable communication parameters for longer range communications of information.

In various embodiments, the terms “short-range” and “long-range” may be relative terms referring to associated communications ranges (or distances) for associated wireless transceivers 114 as compared to each other rather than an objective standard. In one embodiment, for example, the term “short-range” may refer to a communications range or distance for the first wireless transceiver that is shorter than a communications range or distance for another wireless transceiver 114 implemented for the smart card device 102, such as a second wireless transceiver. Similarly, the term “long-range” may refer to a communications range or distance for the second wireless transceiver that is longer than a communications range or distance for another wireless transceiver 114 implemented for the smart card device 102, such as the first wireless transceiver. The embodiments are not limited in this context.

In various embodiments, the terms “short-range” and “long-range” may be relative terms referring to associated communications ranges (or distances) for associated wireless transceivers 114 as compared to an objective measure, such as provided by a communications standard, protocol or interface. In one embodiment, for example, the term “short-range” may refer to a communications range or distance for the first wireless transceiver that is shorter than 300 meters or some other defined distance. Similarly, the term “long-range” may refer to a communications range or distance for the second wireless transceiver that is longer than 300 meters or some other defined distance. The embodiments are not limited in this context.

In one embodiment, for example, the wireless transceiver 114 may comprise a radio designed to communicate information over a wireless personal area network (WPAN) or a wireless local area network (WLAN). The wireless transceiver 180-1 may be arranged to provide data communications functionality in accordance with different types of lower range wireless network systems or protocols. Examples of suitable WPAN systems offering lower range data communication services may include a Bluetooth system as defined by the Bluetooth Special Interest Group, an infra-red (IR) system, an Institute of Electrical and Electronics Engineers (IEEE) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented, and the embodiments are not limited in this context.

In one embodiment, for example, the wireless transceiver 114 may comprise a radio designed to communicate information over a wireless local area network (WLAN), a wireless metropolitan area network (WMAN), a wireless wide area network (WWAN), or a cellular radiotelephone system. The wireless transceiver 180-2 may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver 180-2 may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1×RTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

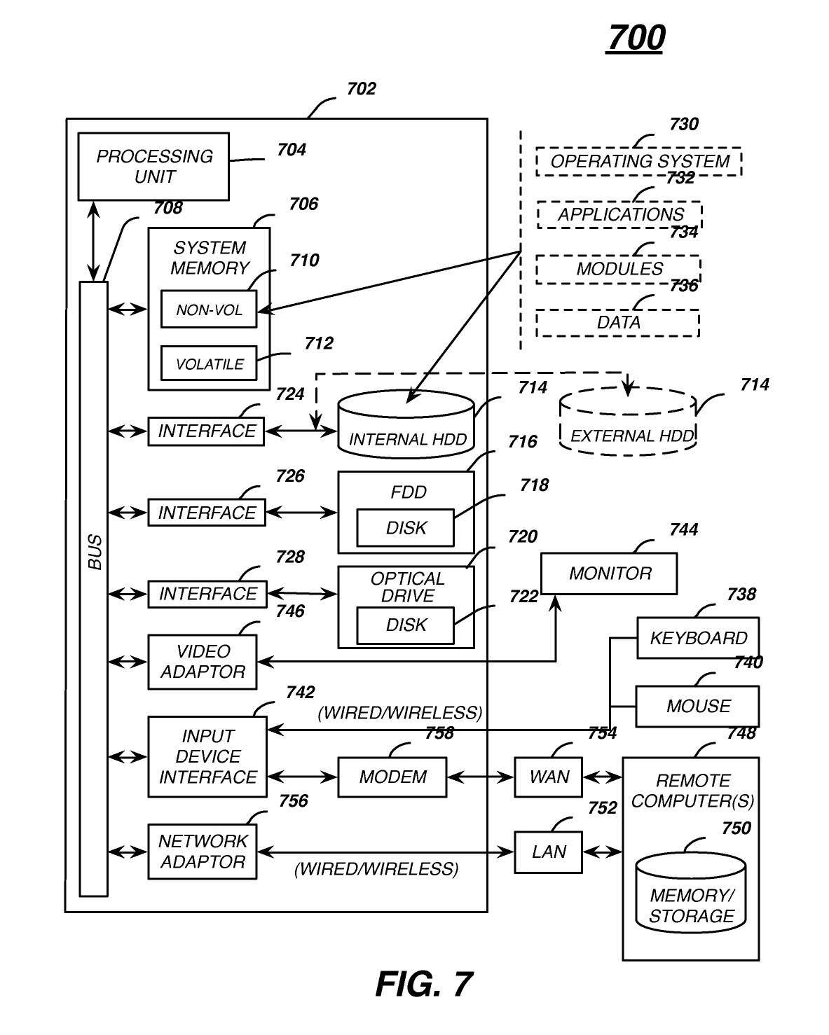

Although not shown, smart card device 102 may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 7. The embodiments, however, are not limited to these examples.

In the illustrated embodiment shown in FIG. 1, the processor 130 may be communicatively coupled to one or more of the memory 108, logic 110, power source 112, transceiver 114, radio 116, antenna 118 and/or interface 120. The memory unit 108 may store the logic 110 arranged for execution by the processor 106 to enable processing capabilities. The logic 110 may generally provide features to enable any of the functionality described herein. Other embodiments are described and claimed.

The host device 104 may comprise, for example, interface 130 and I/O devices 140. In some embodiments, the I/O devices 140 may include but are not limited to display 142, speaker 144, microphone 146, projector 148, camera 150 and keyboard 152. Although the host device 104 shown in FIG. 1 has a limited number of elements in a certain topology, it may be appreciated that the host device 104 may include more or less elements in alternate topologies as desired for a given implementation. For example, any number, type or arrangement of I/O device 140, including devices not shown in FIG. 1, could be used and still fall within the described embodiments.

The one or more I/O devices 140 may be arranged to provide functionality to the host device 104 and/or the smart card device 102 including but not limited to capturing images, exchanging information, capturing or reproducing multimedia information, receiving user feedback, or any other suitable functionality. Non-limiting examples of input/output devices 140 include a camera, QR reader/writer, bar code reader, buttons, switches, input/output ports such as a universal serial bus (USB) port, touch-sensitive sensors, pressure sensors, a touch-sensitive digital display and the like. The embodiments are not limited in this respect.

The host device 104 may comprise one or more displays 142 in some embodiments. The displays 142 may comprise any digital display device suitable for an electronic device. For instance, the displays 142 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content to a user of the host device 104 when used in connection with the smart card device 102. The displays 142 may further include some form of a backlight or brightness emitter as desired for a given implementation.

In various embodiments, the displays 142 may comprise touch-sensitive or touchscreen displays. A touchscreen may comprise an electronic visual display that is operative to detect the presence and location of a touch within the display area or touch interface. In some embodiments, the display may be sensitive or responsive to touching of the display of the device with a finger or hand. In other embodiments, the display may be operative to sense other passive objects, such as a stylus or electronic pen. In various embodiments, displays 142 may enable a user to interact directly with what is displayed, rather than indirectly with a pointer controlled by a mouse or touchpad. Other embodiments are described and claimed.

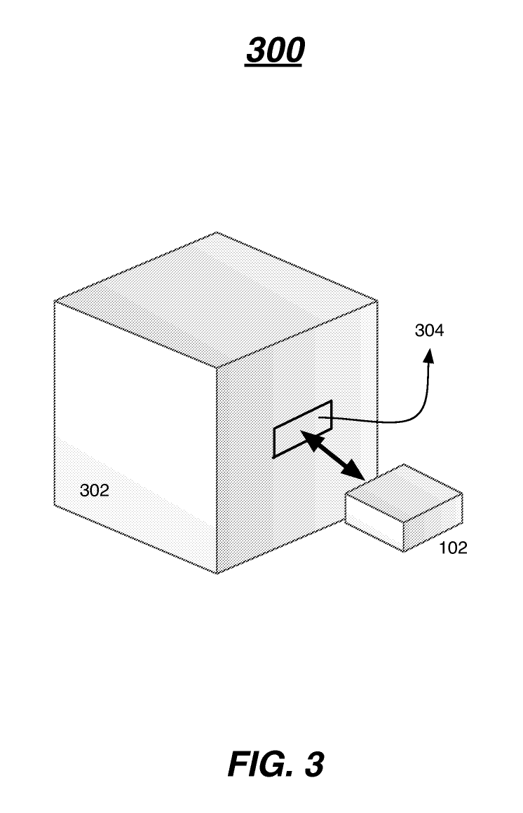

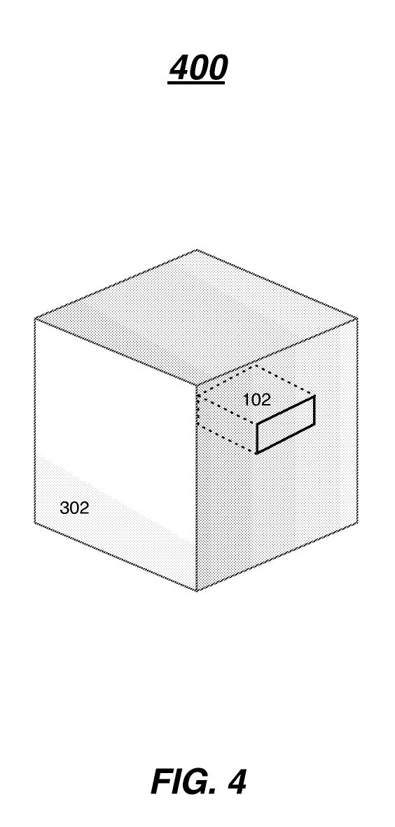

In some embodiments, host device 104 may comprise an enclosure to support the one or more (I/O) devices 140. The enclosure may comprise any suitable case or other structure arranged to support the I/O devices 140 and to removably receive a smart card device 102. For example, the enclosure may be sized and shaped like a smart remote control device, a smart watch, a digital display, a television, a printer, a speaker, a telephone, a smartphone, etc. There is no limit on the size, shape or arrangement of the enclosure as described herein. In various embodiments, the enclosure may comprise an opening to receive and support the smart card device 102. For example, the opening may be sized and shaped to accommodate the size of smart card device 102 as shown and described in more details with reference to FIGS. 3 and 4.

While not limited in this respect, in some embodiments the host device may comprise one or more of a wearable device, a control device, a display device, an audio/video (AN) device, a toy device such as a remote control car or a robot device. For example, the host device may comprise a smartwatch device, a TV remote control device, a smart speaker, etc. One skilled in the art will understand that any suitable device could be arranged as a host device 104 to accommodate smart card device 102 and, as such, the embodiments are not limited to the examples described herein.

In some embodiments, the host device 104 may comprise a dumb device. More particularly, the host device itself may not include components as shown in FIG. 1 as forming part of smart card device 102. For example, host device 104 may not include its own processor, memory, power source, transceiver, etc. Instead, the host device 104 may rely on a smart card device like smart card device 102 for power and processing capabilities. In this manner, any number of host devices could be produced inexpensively and each could be powered and provided with computing capabilities by a common smart card device. In some embodiments, for example, the one or more I/O devices 140 of host device 104 may be operative to receive power from power source 112 of smart card device 102. Similarly, the one or more I/O devices 140 may be controlled by I/O logic 110 of the smart card device 102. Other embodiments are described and claimed. While not shown herein, in some embodiments the host device may include or comprise an independent power supply (e.g. separate and distinct from the power supply of the smart card device) that may power one or more of the components of the host device 104 and/or one or more components of the smart card device 102. Other embodiments are described and claimed.

Host device 104 may comprise an interface to removably couple the host device 104 to a smart card device 102 sized to be removably inserted into an opening of the enclosure of the host device 104 in some embodiments. For example, the interface 130 may correspond, mate and/or couple with the interface 120 of smart card device 120 in some embodiments. In various embodiments, the interface 120 may include one or more male pins or ports and the interface 130 may include corresponding female pins or ports, or vice versa. The embodiments are not limited in this respect.

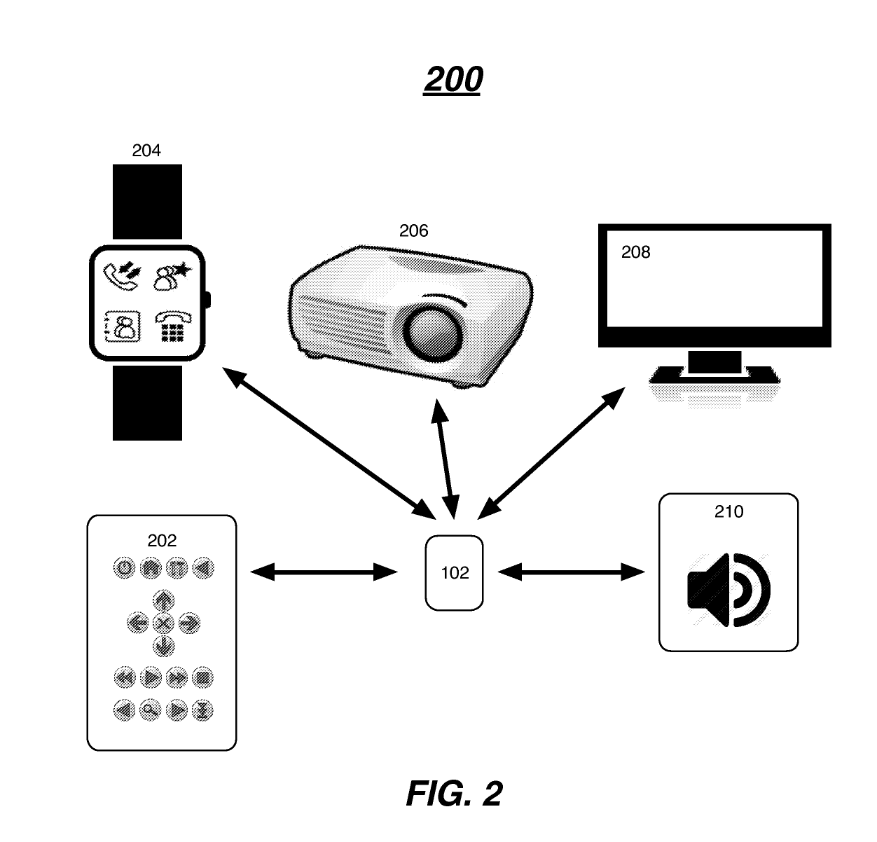

FIG. 2 illustrates an example system 200. In some embodiments, system 200 may illustrate a limited number of examples of possible combinations of a smart card device 102 and a plurality of host devices 202, 204, 206, 208 and 210. As shown in FIG. 2, smart card device 102 may be removably coupled with and/or inserted into one or more of a remote control device 202, a smart watch 204, a projector 206, a display or TV 208 and/or a smart speaker 210. One skilled in the art will appreciate that the embodiments are not limited to the types of host devices 202, 204, 206, 208, 210 shown in FIG. 2.

In various embodiments, the smart card device 102 may be arranged for insertion into any number of host devices. For example, as shown in FIG. 3, a host device may include an opening 304 in its enclosure to accommodate the smart card device 102. The host device 302 shown in FIG. 3 may be representative of a generic host device and is not intended to be limiting. More particularly, the host device 302 may be representative of any example host device described elsewhere herein and also of any host device not described herein as one skilled in the art will readily understand.

As shown in FIG. 4, the smart card device 102 may be fully inserted into the host device 302 in some embodiments. For example, the smart card device 102 may be arranged to be inserted into the opening 304 of the host device 302 such that an exposed edge of the smart card device 102 and the resulting side of the enclosure of the host device 302 form a smooth planar surface. In other embodiments (not shown), the smart card device 102 may be fully inserted into a host device. For example, a host device may include a compartment to house the smart card device 102 inside the enclosure of the host device. In other embodiments, the enclosure may include or comprise a cavity inside the enclosure to receive, support and substantially conceal the smart card device. In these embodiments, the cavity and/or compartment may be accessible by moving one or more components of the enclosure (e.g. sliding open a door or flap, lifting a spring closure, etc.). Other embodiments are described and claimed.

Returning to FIG. 1, in various embodiments, the system 100 may comprise or include a combination or communicative coupling of a smart card device 102 and a host device 104. Stated differently, the smart card device 102 and the host device 104 may, separately, be inoperable or provide limited operability. This may be due to the lack of accessibility peripherals natively associated with the smart card device 102 and the lack of computing components natively associated with the host device 104. When a smart card device 102 is combined with any type of host device 104, however, the resulting computing system may be fully operations for the intended purpose. In various embodiments, the intended purpose may be dictated by the host device as described in more detail below.

As described above, the interface 120 and interface 130 may be arranged or configured to removably couple the smart card device 102 to the host device 104. In various embodiments, logic 110, at least a portion of which is in hardware, may be operative to configure the smart card device 102 based on one or more characteristics of the host device 104. For example, the logic 110 may detect a coupling of the smart card device 102 and the host device 104 and automatically configure one or more applications stored in a memory 108 of the smart card device 102 based on the one or more characteristics of the host device. In various embodiments, the application may comprise an application designed for use with a particular host device or a particular type of host device. For example, if the smart card device 102 is inserted into a smart watch host device, a watch and/or watch notification application may be automatically configured and/or executed to enable particular functionality associated with the smart watch host device. The embodiments are not limited in this respect.

In other embodiments, the logic 110 may detect a coupling of the smart card device 102 and the host device 104 and automatically download an application associated with the host device 104 based on the one or more characteristics of the host device 104. For example, if the smart card device 102 is inserted into a remote control host device, and the smart card device 102 does not currently have any applications or instructions associated with a remote control host device, the smart card device 102 may automatically download, install and execute a suitable application for use with the remote control host device. Other embodiments are described and claimed.

In various embodiments, configuration of the smart card device 102 based on one or more characteristics of the host device may comprise selecting a processor circuit 106-1 or 106-2 of the smart card device 102. For example, the characteristics of the host device may comprise, but are not limited to, one or more of an intended use of the host device, available I/O devices associated with the host device, size of the host device, shape of the host device, configuration of the I/O devices of the host device and the like. Based on any number of these characteristics, it may be advantageous to select one of the processors 106-1 or 106-2. In some embodiments, the processor circuit 106-1 may operative at a first frequency and may be used to execute a first operating system 112-1 while the processor circuit 106-2 may operate a second frequency (less than the frequency) and may execute a second operating system 112-2. In these embodiments, the logic 110 may automatically select one of the first preprocessor circuit 106-1 and first operating system 112-1 or second processor circuit 106-2 and second operating system 112-2 based on the one or more characteristics of the host device. The embodiments are not limited in this respect.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context

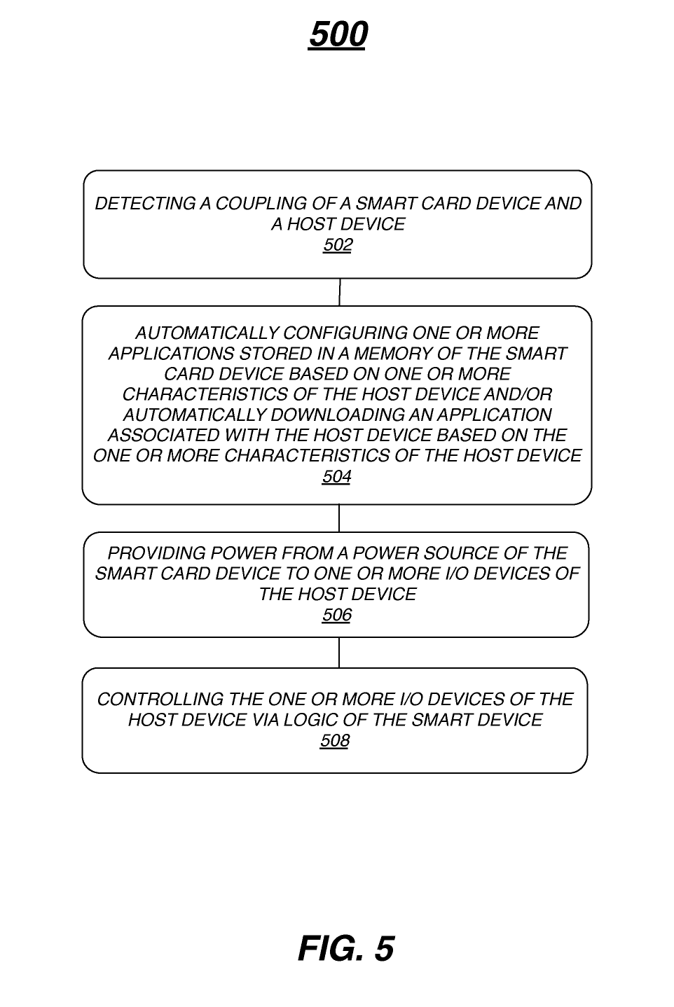

FIG. 5 illustrates one embodiment of a first logic flow 500. The logic flow 500 may be representative of some or all of the operations executed by one or more embodiments described herein. For example, the logic flow 500 may illustrate operations performed by the smart card device 102, host device 104 or computing system 100 comprising a combination of a smart card device 102 and host device 104.

In the illustrated embodiment shown in FIG., the logic flow 500 may include detecting a coupling of a smart card device and a host device at 502. For example, the smart card device 102 may comprise one or more processor circuits and an interface on a smart card sized to be removably inserted into an enclosure of the host device 104 and the host device 104 may comprise one or more input/output (I/O) devices 140. At 504, the logic flow may include automatically configuring one or more applications stored in a memory of the smart card device based on one or more characteristics of the host device or automatically download an application associated with the host device based on the one or more characteristics of the host device. For example, logic 110 may determined, based on the characteristics of host device 104, if an application is available on smart card device 102 that is associated with the host device 104. If so, that application may be automatically configured and executed. If not, a suitable application for host device 104 may be automatically downloaded.

The logic flow at 506 may comprise providing power from a power source of the smart card device to the one or more I/O devices of the host device. For example, the power source 112 of the smart card device 102 may be operative to provide, via interfaces 120, 130, power to the one or more I/O devices 140 of host device 104. In various embodiments, the logic flow at 508 may comprise controlling the one or more I/O devices of the host device via logic of the smart card device. For example, the logic 110 of smart card device 102 may be operative to control the one or more I/O devices 140 of host devices 104. The embodiments are not limited in this respect.

While not shown in FIG. 5, in various embodiments the logic flow may comprise detecting a coupling of the smart card device and a second host device and automatically configuring or downloading a second application associated with the second host device. For example, if the smart card device 102 is removed from host device 104 and is inserted into another host device, a suitable second application associated with the second/different host devices may be configured or downloaded.

In some embodiments, the logic flow may comprise selecting a first processor circuit of the smart card device to execute a first operating system based on the one or more characteristics of the host device or selecting a second processor circuit of the smart card device to execute a second operating system based on the one or more characteristics of the host device the first processor circuit to operate at a first frequency and the second processor circuit to operate at a second frequency less than the first frequency. For example, the first processor may comprise a CPU arranged to execute a complete OS while the second processor may comprise a MCU arranged to executed a limited OS, for example a small scale OS suitable for use with a remote control device or a smart watch. In various embodiments, the second processor may comprise a processor that operates at a lower frequency and consumes less power from power source 112. Other embodiments are described and claimed.

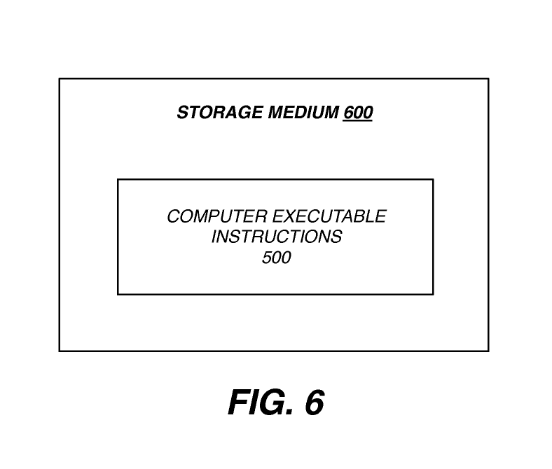

FIG. 6 illustrates an embodiment of a first storage medium. As shown in FIG. 6, the first storage medium includes a storage medium 600. Storage medium 600 may comprise an article of manufacture. In some examples, storage medium 600 may include any non-transitory computer readable medium or machine-readable medium, such as an optical, magnetic or semiconductor storage. Storage medium 600 may store various types of computer executable instructions, such as instructions to implement logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 7 illustrates an embodiment of an exemplary computing architecture 700 suitable for implementing various embodiments as previously described. In one embodiment, the computing architecture 700 may comprise or be implemented as part of smart card device 102, for example.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, such as those described with reference to the processor 106 shown in FIG. 1.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710,712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the smart card device 102 and/or host device 104 as previously described with reference to FIGS. 1-6 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. The examples provided below are intended to be exemplary and non-limiting.

In a first example, a smart card device may comprise one or more processor circuits, an interface coupled to the one or more processor circuits, the smart card device sized to be removably inserted into a host device and the interface configured to removably couple the smart card device to the host device, and logic, at least a portion of which is in hardware, the logic to configure the smart card device based on one or more characteristics of the host device.

In another example of a smart card device, the logic may detect a coupling of the smart card device and the host device and to automatically configure one or more applications stored in a memory of the smart card device based on the one or more characteristics of the host device.

In another example of a smart card device, the logic may detect a coupling of the smart card device and the host device and to automatically download an application associated with the host device based on the one or more characteristics of the host device.

In another example, a smart card device may comprise memory coupled to the one or more processor circuits, a power source coupled to the one or more processor circuits, a radio coupled to the one or more processor circuits, and one or more antennas coupled to the radio.

In another example of a smart card device, the one or more processor circuits may comprise a first processor circuit to execute a first operating system and a second processor circuit to execute a second operating system, the logic to automatically select one of the first processor and first operating system or second processor and second operating system based on the one or more characteristics of the host device.

In another example of a smart card device, the first processor circuit may operate at a first frequency and the second processor circuit may operate at a second frequency less than the first frequency.

In another example of a smart card device, the interface may comprise a plurality of input/output (I/O) pins or ports.

In another example of a smart card device, the smart card device may be arranged for plug and play operation with a plurality of host devices.

In another example of a smart card device, the host device may comprise an enclosure to support the one or more I/O devices, the enclosure comprising one or more of an opening to receive and support the smart card device or a cavity inside the enclosure to receive, support and substantially conceal the smart card device.

In another example of a smart card device, the host device may comprise one or more of a wearable device, a control device, a display device, or an audio/video (A/V) device.

In one example, a host device may comprise an enclosure to support one or more input/output (I/O) devices, and an interface to removably couple the host device to a smart card device sized to be removably inserted into an opening or cavity of the enclosure, the smart card device comprising one or more processor circuits, an interface to removably couple with the interface of the host device, and logic at least a portion of which is in hardware, the logic to configure the smart card device based on one or more characteristics of the host device.

In another example of a host device, the logic may detect a coupling of the smart card device and the apparatus and may automatically a first processor circuit or a second processor circuit of the one or more processor circuits.

In another example of a host device, the first processor circuit may operate at a first frequency and to execute a first operating system and the second processor circuit may operate at a second frequency and to execute a second operating system, the second frequency comprising a lower frequency than the first frequency.

In another example of a host device, the logic may detect a coupling of the smart card device and the host device and may automatically configure one or more applications stored in a memory of the smart card device based on the one or more characteristics of the apparatus.

In another example of a host device, the logic may detect a coupling of the smart card device and the host device and may automatically download an application associated with the apparatus based on the one or more characteristics of the apparatus.

In another example of a host device, the one or more I/O devices may receive power from a power source of the smart card device.

In another example of a host device, the one or more I/O devices may be controlled by I/O logic of the smart card device, at least a portion of the logic comprising hardware.

In another example of a host device, the host device may comprise one or more of a wearable device, a control device, a display device, or an audio/video (A/V) device.

In one example, a system may comprise a smart card device comprising one or more processor circuits, an interface coupled to the one or more processor circuits, memory coupled to the one or more processor circuits, a power source coupled to the one or more processor circuits, a radio coupled to the one or more processor circuits and one or more antennas coupled to the radio, the smart card device sized to be removably inserted into a host device and the interface to removably couple the smart card device to the host device, a host device comprising an enclosure to support one or more input/output (I/O) devices, the enclosure comprising an opening to receive the smart card device and an interface to removably couple to the interface of the smart card device, and logic at least a portion of which is in hardware, the logic to configure the smart card device based on one or more characteristics of the host device.

In another example of a system, the logic may detect a coupling of the smart card device and the host device and may automatically configure one or more applications stored in the memory of the smart card device based on the one or more characteristics of the host device or to automatically download an application associated with the host device based on the one or more characteristics of the host device.

In another example of a system, the one or more processor circuits may comprise a first processor circuit to execute a first operating system and a second processor circuit to execute a second operating system, the logic to automatically select one of the first preprocessor and first operating system or second processor and second operating system based on the one or more characteristics of the host device.

In another example of a system, the first processor circuit may operate at a first frequency and the second processor circuit may operate at a second frequency less than the first frequency.

In another example of a system, the interface of the smart card device may comprise a plurality of input/output (I/O) pins or ports corresponding to plurality of I/O pins or ports of the interface of the host device.

In another example of a system, the smart card device may be arranged for plug and play operation with a plurality of host devices.

In another example of a system, the host device may comprise one or more of a wearable device, a control device, a display device, or an audio/video (A/V) device and the one or more I/O devices of the host device to receive power from a power source of the smart card device and to be controlled by I/O logic of the smart card device, at least a portion of the logic comprising hardware.

In one example, an article may comprise a non-transitory storage medium containing a plurality of instructions that if executed enable a system to detect a coupling of a smart card device and a host device, the smart card device comprising one or more processor circuits and an interface on a smart card sized to be removably inserted into an enclosure of the host device, the host device comprising one or more input/output (I/O) devices, automatically configure one or more applications stored in a memory of the smart card device based on one or more characteristics of the host device or automatically download an application associated with the host device based on the one or more characteristics of the host device, provide power from a power source of the smart card device to the one or more I/O devices of the host device, and control the one or more I/O devices of the host device via logic of the smart card device.

In another example, an article may comprise instructions that if executed enable the system to detect a coupling of the smart card device and a second host device, and automatically configure or download a second application associated with the second host device.

In another example, an article may comprise instructions that if executed enable the system to select a first processor circuit of the smart card device to execute a first operating system based on the one or more characteristics of the host device, or select a second processor circuit of the smart card device to execute a second operating system based on the one or more characteristics of the host device, the first processor circuit to operate at a first frequency and the second processor circuit to operate at a second frequency less than the first frequency.

In one example, a method may comprise detecting a coupling of a smart card device and a host device, the smart card device comprising one or more processor circuits and an interface on a smart card sized to be removably inserted into an enclosure of the host device, the host device comprising one or more input/output (I/O) devices, automatically configuring one or more applications stored in a memory of the smart card device based on one or more characteristics of the host device or automatically download an application associated with the host device based on the one or more characteristics of the host device, providing power from a power source of the smart card device to the one or more I/O devices of the host device, and controlling the one or more I/O devices of the host device via logic of the smart card device.

In another example, a method may comprise detecting a coupling of the smart card device and a second host device, and automatically configuring or downloading a second application associated with the second host device.

In another example, a method may comprise selecting a first processor circuit of the smart card device to execute a first operating system based on the one or more characteristics of the host device, selecting a second processor circuit of the smart card device to execute a second operating system based on the one or more characteristics of the host device, the first processor circuit to operate at a first frequency and the second processor circuit to operate at a second frequency less than the first frequency.

In one example, an apparatus may comprise means for performing the method according to any of the examples described herein.

In one example, at least one machine-readable medium may comprise a plurality of instructions that in response to being executed on a computing device cause the computing device to carry out a method according to any of the examples described herein.

In one example, a wireless communication device may be arranged to perform the method according to any of the examples described herein.

The foregoing examples and embodiments are set forth for purposes of illustration and not limitation. As such, other embodiments are described and claimed.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A smart card device, comprising:
one or more processor circuits;
an interface coupled to the one or more processor circuits, the smart card device sized to be removably inserted into a host device and the interface configured to removably couple the smart card device to the host device; and
logic, at least a portion of which is in hardware, the logic to configure the smart card device based on one or more characteristics of the host device.

2. The apparatus of claim 1, the logic to detect a coupling of the smart card device and the host device and to automatically configure one or more applications stored in a memory of the smart card device based on the one or more characteristics of the host device.

3. The smart card device of claim 1, the logic to detect a coupling of the smart card device and the host device and to automatically download an application associated with the host device based on the one or more characteristics of the host device.

4. The smart card device of claim 1, comprising:
memory coupled to the one or more processor circuits;
a power source coupled to the one or more processor circuits;
a radio coupled to the one or more processor circuits; and
one or more antennas coupled to the radio.

5. The smart card device of claim 1, the one or more processor circuits comprising a first processor circuit to execute a first operating system and a second processor circuit to execute a second operating system, the logic to automatically select one of the first processor and first operating system or second processor and second operating system based on the one or more characteristics of the host device.

6. The smart card device of claim 5, the first processor circuit to operate at a first frequency and the second processor circuit to operate at a second frequency less than the first frequency.

7. The smart card device of claim 1, the interface comprising a plurality of input/output (I/O) pins or ports.

8. The smart card device of claim 1, the smart card device arranged for plug and play operation with a plurality of host devices.

9. The smart card device of claim 1, the host device comprising an enclosure to support the one or more I/O devices, the enclosure comprising one or more of an opening to receive and support the smart card device or a cavity inside the enclosure to receive, support and substantially conceal the smart card device.

10. The smart card device of claim 1, the host device comprising one or more of a wearable device, a control device, a display device, or an audio/video (A/V) device.

11. A host device, comprising:
an enclosure to support one or more input/output (I/O) devices; and
an interface to removably couple the host device to a smart card device sized to be removably inserted into an opening or cavity of the enclosure, the smart card device comprising one or more processor circuits, an interface to removably couple with the interface of the host device, and logic at least a portion of which is in hardware, the logic to configure the smart card device based on one or more characteristics of the host device.

12. The host device of claim 11, the logic to detect a coupling of the smart card device and the host device and to automatically select a first processor circuit or a second processor circuit of the one or more processor circuits.

13. The host device of claim 12, the first processor circuit to operate at a first frequency and to execute a first operating system and the second processor circuit to operate at a second frequency and to execute a second operating system, the second frequency comprising a lower frequency than the first frequency.

14. The host device of claim 11, the logic to detect a coupling of the smart card device and the host device and to automatically configure one or more applications stored in a memory of the smart card device based on the one or more characteristics of the host device.

15. The host device of claim 11, the logic to detect a coupling of the smart card device and the host device and to automatically download an application associated with the host device based on the one or more characteristics of the host device.

16. The host device of claim 11, the one or more I/O devices to receive power from a power source of the smart card device.

17. The host device of claim 11, the one or more I/O devices controlled by I/O logic of the smart card device, at least a portion of the logic comprising hardware.

18. The host device of claim 11, the host device comprising one or more of a wearable device, a control device, a display device, or an audio/video (A/V) device.

19. A system, comprising:
a smart card device comprising one or more processor circuits, an interface coupled to the one or more processor circuits, memory coupled to the one or more processor circuits, a power source coupled to the one or more processor circuits, a radio coupled to the one or more processor circuits and one or more antennas coupled to the radio, the smart card device sized to be removably inserted into a host device and the interface to removably couple the smart card device to the host device;
a host device comprising an enclosure to support one or more input/output (I/O) devices, the enclosure comprising an opening or cavity to receive the smart card device and an interface to removably couple to the interface of the smart card device; and
logic at least a portion of which is in hardware, the logic to configure the smart card device based on one or more characteristics of the host device.

20. The system of claim 19, the logic to detect a coupling of the smart card device and the host device and to automatically configure one or more applications stored in the memory of the smart card device based on the one or more characteristics of the host device or to automatically download an application associated with the host device based on the one or more characteristics of the host device.

21. The system of claim 19, the one or more processor circuits comprising a first processor circuit to execute a first operating system and a second processor circuit to execute a second operating system, the logic to automatically select one of the first preprocessor and first operating system or second processor and second operating system based on the one or more characteristics of the host device.

22. The system of claim 21, the first processor circuit to operate at a first frequency and the second processor circuit to operate at a second frequency less than the first frequency.

23. The system of claim 19, the interface of the smart card device comprising a plurality of input/output (I/O) pins or ports corresponding to plurality of I/O pins or ports of the interface of the host device.

24. The system of claim 19, the smart card device arranged for plug and play operation with a plurality of host devices.

25. The system of claim 19, the host device comprising one or more of a wearable device, a control device, a display device, or an audio/video (A/V) device and the one or more I/O devices of the host device to receive power from a power source of the smart card device and to be controlled by I/O logic of the smart card device, at least a portion of the logic comprising hardware.

26.-28. (canceled)
